(19) United States
(12) Patent Application Publication
(10) Pub. No.: US 2003/0158822 A1
(43) Pub. Date: Aug. 21, 2003

(54) Profile information disclosure method, profile information disclosure program and profile information disclosure apparatus

(75) Inventor: Kinji Kawaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/199,131

(22) Filed: Jul. 22, 2002

(30) Foreign Application Priority Data
Feb. 15, 2002 (JP) 2002-039111

(51) Int. Cl. G06F 17/60

(52) U.S. Cl. 705/75

(57) ABSTRACT

A profile information disclosure method, profile information disclosure program and profile information disclosure apparatus which can reduce the effort required for inputting profile information, by providing a mechanism for disclosing profile information to a variety of sites, thereby eliminating the need for inputting profile information many times over.

### BACKGROUND OF THE INVENTION

1. Field of the Invention

The present invention relates to technology for reducing the effort required for inputting profile information at a variety of sites on a computer network.

2. Related Art of the Invention

Recently, with the rapid progress in computer networks, the use of computer networks as represented by the Internet is becoming widespread worldwide. A variety of services are provided over these computer networks such as online shopping, information distribution and the like.

Often, member registration must be performed at a service site providing a service, before the service can be received. In the member registration, the user of the service is required to input profile information such as his/her name and the like, so that a service which best fits the user can be provided.

However, since this member registration is only valid for this service site, the user must perform member registration each time he/she wishes to receive a new service from another service site. Because the profile information required to be input for member registration often has many common entries such as name, address, contact details and the like, inputting these same entries many times is troublesome, and the effort required is considerable.

Furthermore, if the profile information is changed due to the user moving house or the like, the profile information must be updated for every service sites for which the user has registered as a member. Consequently, even in a case where only a single entry of such profile information is changed, the effort required for changing process is considerable.

Consequently, taking into consideration the above problems associated with conventional technology, an object of the present invention is to provide profile information disclosure technology which provides a mechanism for disclosing profile information to a variety of sites, thereby eliminating the need for the user to input his/her profile information many times over and reducing the effort required from the user of a service.

### Summary of the Invention

In order to achieve the above object, in profile information disclosure technology of the present invention, profile information of a user is registered, and at the same time, when an information disclosure request appended with identification information of the user is received, determination is made as to whether or not the request is valid based on this identification information, and if the request is determined to be valid, the profile information of the user specified by the identification information is disclosed.

According to such a configuration, if the information disclosure request appended with identification information of the user is received, the determination, is first made as to whether or not the request is valid, in other words, user authentication is performed, based on the identification information. If the request is valid, the profile information of the user specified by the identification information is disclosed. Consequently, since the profile information is disclosed on condition that the user authentication is performed, the effort required for the input of profile information can be reduced while the unnecessary leakage of profile information can be prevented.

Furthermore, it is desirable that, when an information update request appended with identification information of the user is received, the profile information of the user specified by that identification information is updated. According to such a configuration, the profile information can be updated at any time.

In addition, it is desirable that, when an update confirmation request appended with identification information of the user is received, if the request is determined to be valid based on the identification information and if the profile information of the user specified by the identification information has been updated, the updated profile information is disclosed. According to such a configuration, the most up to date profile information can always be disclosed.

At this time, it is desirable that a disclosure level for the profile information is set according to the category of the site to which the information is disclosed, and that only the profile information suited to the disclosure level is disclosed. Furthermore, it is desirable that profile information non-disclosure sites are also set, and the profile information is disclosed to information disclosure sites with the exception of these non-disclosure sites.

According to such a configuration, since only the profile information suited to the disclosure level is disclosed, the disclosure of profile information irrelevant to the recipient is avoided, and the disclosure of profile information which the user prefers not to disclose can be prevented. Furthermore, since the profile information is disclosed to sites with the exception of the non-disclosure sites, the disclosure of profile information to untrustworthy sites is avoided, and unauthorized use thereof can be prevented.

In addition, it is desirable that the identification information is a digital certificate. Such a digital certificate offers tight security, preventing the leakage of profile information.

Other objects and aspects of this invention will become apparent in the following description of embodiments with reference to the attached drawings.

### Brief Explanation of the Drawings

FIG. 1 is an explanatory diagram showing an implementation mode of an information disclosure apparatus according to the present invention.

FIG. 2 is an explanatory diagram showing the operation of the above information disclosure apparatus.

FIG. 3 is a flow chart showing a profile information registration process.

FIG. 4 is an explanatory diagram of profile information.

FIG. 5 is an explanatory diagram of a disclosure level.

FIG. 6 is a flow chart showing a member registration process.

FIG. 7 is a flow chart showing a profile information update process.

FIG. 8 is a flow chart showing a service usage process.

FIG. 9 is a flow chart showing an example of a member registration process with missing entries.

FIG. 10 is a flow chart showing another example of a member registration process with missing entries.

### PREFERRED EMBODIMENTS

As follows is a detailed description of the present invention, with reference to the attached drawings.

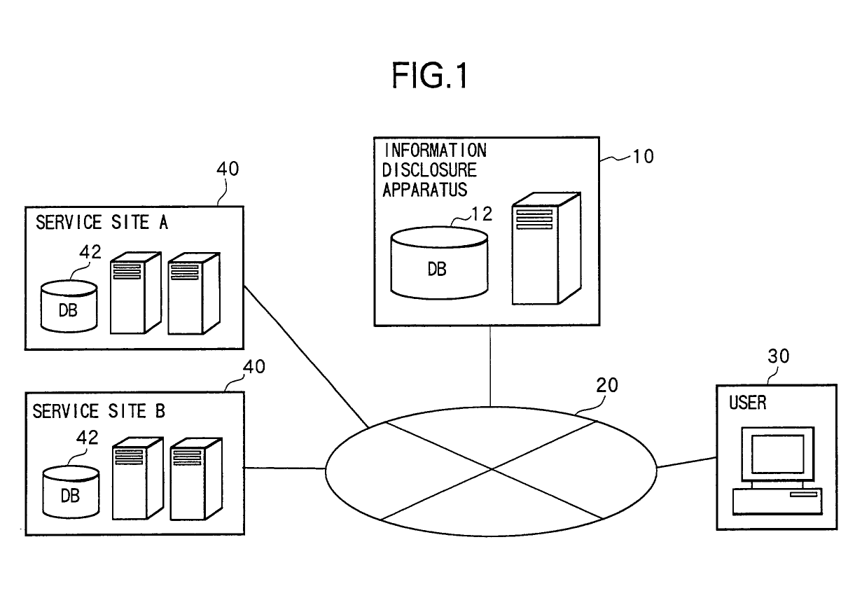

FIG. 1 shows an implementation mode for providing a profile information disclosure service (hereafter referred to as a “disclosure service”) using a profile information disclosure apparatus (hereafter referred to as an “information disclosure apparatus”) which embodied the present invention. The information disclosure apparatus is constructed on a computer comprising at least a central processing unit (CPU) and a memory, and various functions relating to the disclosure of profile information are realized by a program which is loaded into the memory.

An information disclosure apparatus 10 comprises a database (DB) 12 in which are registered the profile information of users of the disclosure service, a disclosure level and a non-disclosure site table. Various entries relating to the individual attribute of a user are set in the profile information. Furthermore, within the disclosure level, whether or not each entry of the profile information is disclosed to a variety of sites that are to be disclosed with profile information, is set for each of different service site categories. In the non-disclosure site table, the site information of sites to which the user refuses disclosure of profile information is set, so that unauthorized use of the profile information can be prevented.

A user PC (personal computer) 30 and service servers 40 of service sites A and B for providing a variety of services are connected to the information disclosure apparatus 10 via a computer network 20 such as the internet. Here, the user PC 30 comprises a browser (not shown in the figure) which functions as browsing software of web pages, and the service servers 40 of the service sites A and B each comprises a DB 42 in which the member information of users of the service is registered.

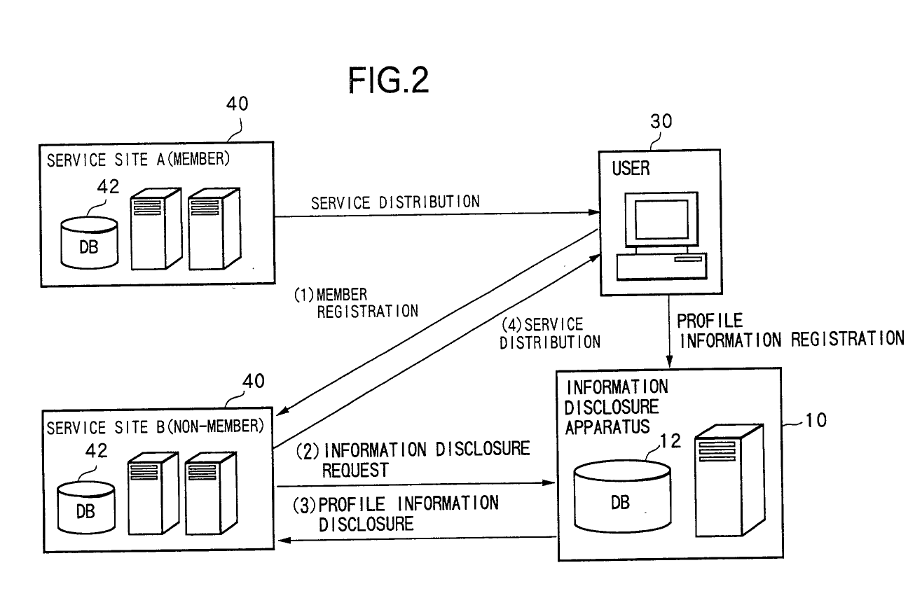

Next, the operation of the information disclosure apparatus 10 is described with reference to FIG. 2.

Since the member information of a user who is a member of the service site A is registered in the DB 42, he/she can use the service in accordance with his/her member information. However, when the user attempts to use the service of service site B of which he/she is not a member, he/she must perform member registration in service site B by inputting profile information. Since the profile information relates to the individual attributes of the user, there are often common entries such as name, address, contact information, job title and the like. Consequently, it is extremely troublesome for the user to input the same profile information every time he/she performs member registration.

Now, by registering the profile information in the DB 12 of the information disclosure apparatus 10, and during member registration in the variety of sites disclosing this information according to the request of the user, the effort required for inputting profile information can be reduced.

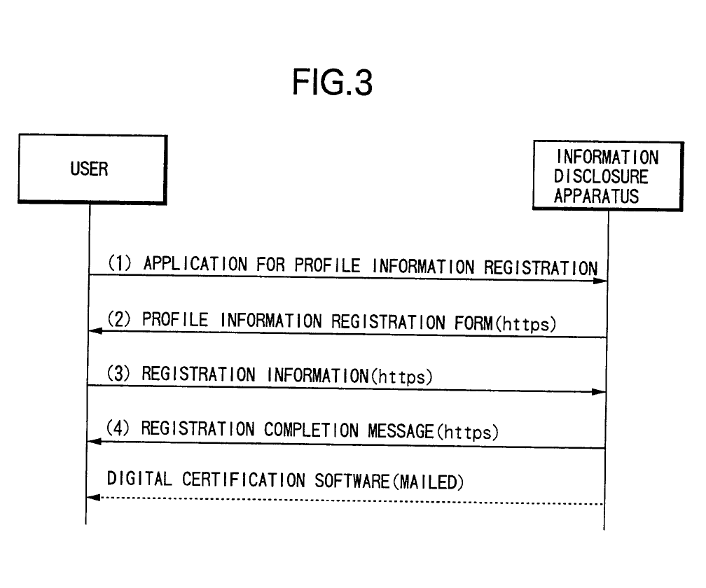

In order to use the disclosure service, firstly, a profile information registration application is sent to the information disclosure apparatus 10 as shown in FIG. 3 (process (1)). Subsequently, a profile information registration form is sent to the user from the information disclosure apparatus 10 (process (2)). Here, it is desirable that the profile information registration form is sent using a secure protocol such as https (HyperText Transfer Protocol Security). Hereafter, the transmission marked with “https” in the figures is desirable to be performed using the secure protocol.

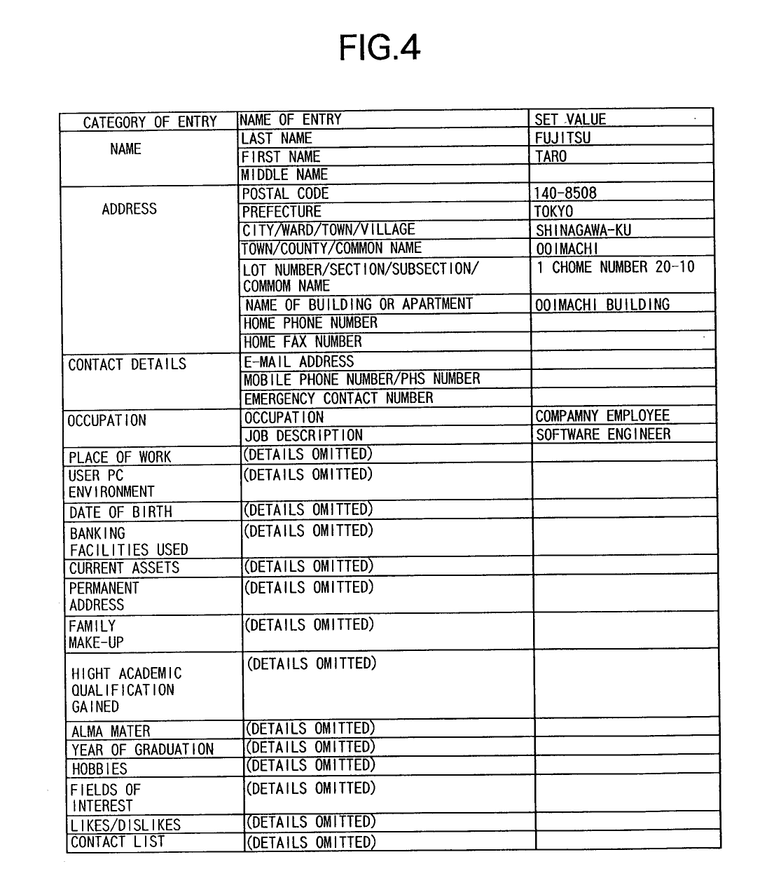

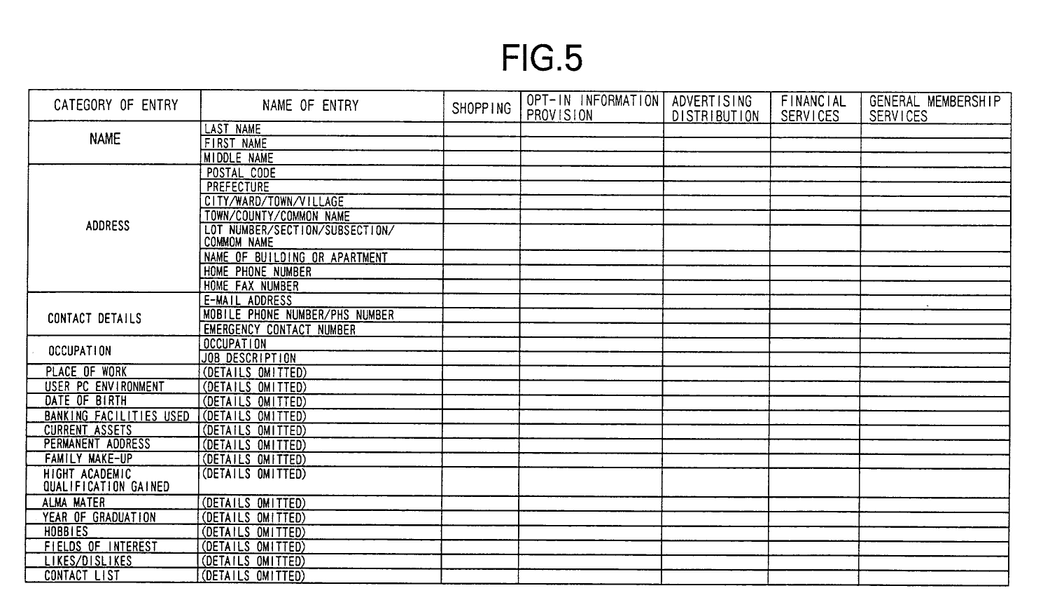

The user who has received the profile information registration form inputs each entry of his/her profile information, and sets the disclosure level designating which entries are disclosed to each service category, as shown in FIG. 4 and FIG. 5. Examples of the profile information are name, address, contact details, occupation, employer, user PC environment, date of birth, banking facilities used, current assets, permanent address, family make-up, highest academic qualification gained, alma mater, year of graduation, hobbies, fields of interest, likes/dislikes, and contact lists. On the other hand, examples of the different types of service categories include shopping, opt-in information provision, advertising distribution, financial services and general membership services. After the input of the profile information and the setting of the disclosure level are completed, the profile information and the disclosure level (hereafter called the “registration information”) are sent to the information disclosure apparatus 10 by, for example, clicking a “register” button (process (3)).

Moreover, if the user does not wish to disclose specific entries of profile information, those entries could also be left blank. Furthermore, if necessary, the site information of sites to which the user does not allow disclosure of profile information may also be set at the same time as the input of the profile information and the setting of the disclosure level.

In the information disclosure apparatus 10 having received the registration information, the profile information and the disclosure level are registered in the DB 12. After the profile information and the disclosure level have been registered, a registration completion message is sent to the user (process (4)).

Here, the series of processes (1) through (4) correspond to a step of registering the profile information of the user, a registration function, registration means, a step of setting disclosure level and a step of setting the non-disclosure sites.

Subsequently, digital certification software is mailed to the user. When the digital certification software is installed on the PC 30, the digital certificate required for user authentication can be used. Moreover, user authentication is not limited to the digital certificate, and for example, user identification information comprising user identification and a password may also be used. However, from the viewpoint of maintaining tight security and preventing leak of the profile information, it is desirable that digital certificate is used.

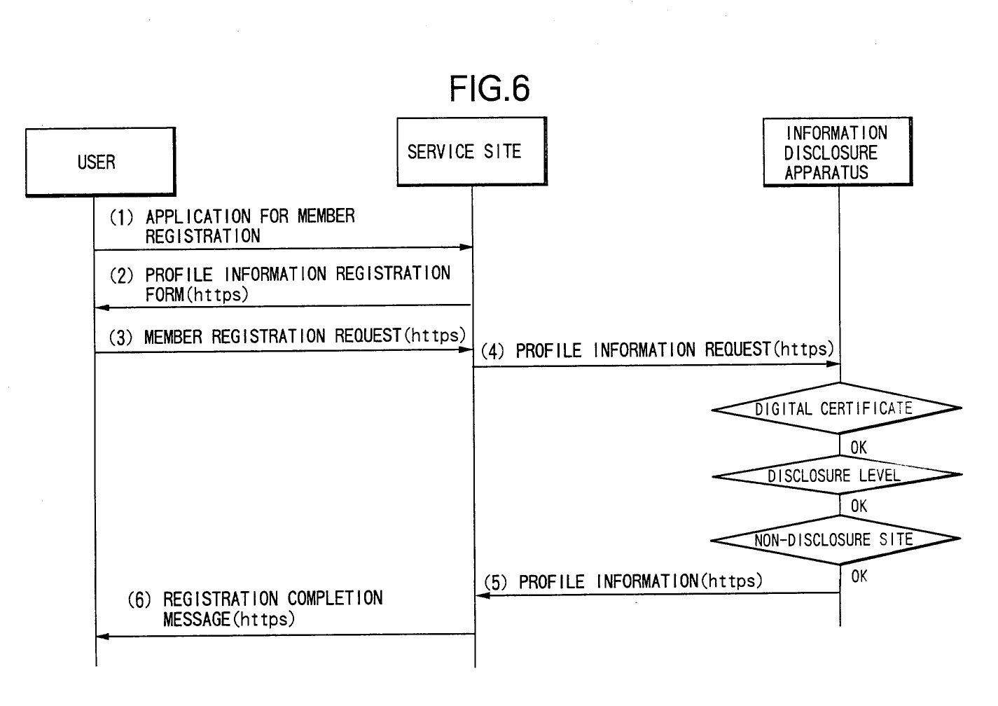

When the user performs member registration anew, as shown in FIG. 6, the user sends a member registration application to the service site where he/she wishes to register as a member, indicating his/her intent to use the disclosure service (process (1)). Then, a profile information registration form with information about the rules of use and the like is sent from the service site to the user (process (2)).

If the user receives the profile information registration form and the user agrees to the rules of use, then by clicking the “register” button for example, a member registration request with the digital certificate is sent to the service site (process (3)).

The service site having received the member registration request, sends a profile information request relating to the user applying for member registration to the information disclosure apparatus 10 (process (4)). The digital certificate of the user is also sent at this time to facilitate user authentication.

The information disclosure apparatus 10 having received the profile information request, determines whether or not the profile information relating to the user may be disclosed to the service site. In other words, a public key is taken out from the digital certificate so that the user authentication is performed, and also the disclosure level corresponding to the category of the service site is confirmed. Specifically, the disclosure level for the user is confirmed, and the confirmation is made as to whether or not each entry may be disclosed to the category of service site to which the profile information is to be provided. Furthermore, from the viewpoint of preventing the disclosure of profile information which the user does not wish to disclose, a determination is made as to whether or not the service site which requests the profile information is a non-disclosure site registered in the non-disclosure site table. Here, these user authentication processes correspond to a step of determining whether or not the request is valid, a determination function and determination means (the same applies in the following).

If no problems arise relating to the digital certificate, the disclosure level or non-disclosure sites, then the profile information of the user is retrieved from the DB 12 and sent to the service site (process (5)). The service site having received the profile information, performs the member registration process based on the received profile information, and the membership information is registered in the DB 42 thereof. Here, the process of sending the profile information (process (5)) corresponds to a step of disclosing the profile information, a disclosure function and disclosure means.

At the service site, after the membership information is registered, a registration completion message is sent to the user (process (6)). Subsequently, the user can begin to use the service site.

In this manner, if the necessary profile information is disclosed from the information disclosure apparatus 10 to the service site subject to user authentication, then the effort required for inputting profile information for member registration can be reduced. At this time, since the profile information which is able to be disclosed is set in detail according to the category of the service site, the disclosure of profile information which is irrelevant to the service is avoided, and the disclosure of profile information which the user does not wish to disclose can be prevented. Furthermore, since the site information of those sites to which the user does not allow the disclosure of profile information is registered in the non-disclosure site table, the disclosure of profile information to untrustworthy service sites is avoided, and the unauthorized use thereof can be prevented.

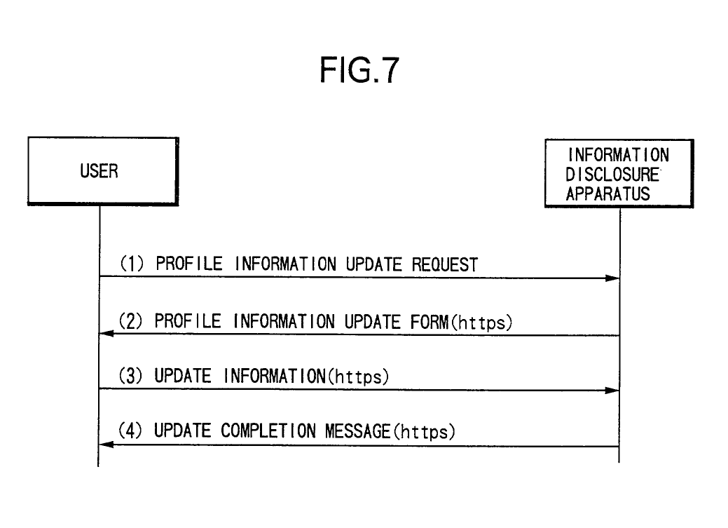

When updating the profile information, instead of sending an update request to each service site, a profile information update request is sent to the information disclosure apparatus 10 as shown in FIG. 7 (process (1)). Then, a profile information update form is sent to the user from the information disclosure apparatus 10 (process (2)). The user having received this profile information update form, updates each entry of his/her profile information, the disclosure level and the non-disclosure site table as necessary, and by then clicking an “update” button for example, sends the updated information with the digital certificate to the information disclosure apparatus 10 (process (3)).

The information disclosure apparatus 10 having received the updated information, performs a user authentication based on the digital certificate, and then updates the profile information, the disclosure level and the non-disclosure site table relating to the user. After the profile information and the like have been updated, an update completion message is sent to the user (process (4)).

Here, the series of processes (1) through (4) shown in FIG. 7 correspond to a step of updating the profile information.

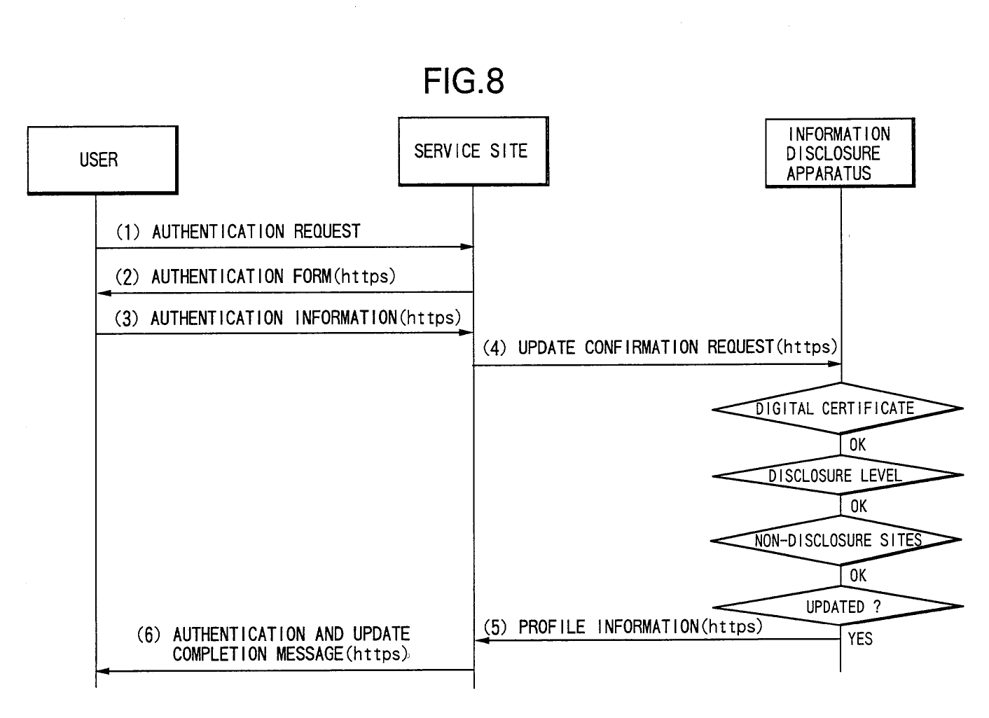

As shown in FIG. 8, the user of the service site sends an authentication request to the service site, indicating his/her intent to use the disclosure service (process (1)). Then, an authentication form for the purposes of user authentication is sent to the user from the service site (process (2)). The user having received the authentication form, inputs a user ID and a password assigned by the service site, and by then clicking an “authentication” button for example, sends authentication information with the digital certificate to the service site (process (3)).

The service site having received the authentication information, performs a user authentication based on the received user ID and password, and an update confirmation request is then sent to the information disclosure apparatus 10 to determine whether or not the profile information of the user has been updated (process (4)). At this time, in addition to the digital certificate, the time and date of the last log-in of the user to the service site is appended to the update confirmation request.

The information disclosure apparatus 10 having received this update confirmation request, determines whether or not the profile information may be disclosed to the service site, in the same manner as in FIG. 6, and also determines whether or not the profile information has been updated after the last log-in of the user. If the profile information has been updated, profile information corresponding to the disclosure level is sent to the service site (process (5)).

Here, the process for determining whether or not the profile information has been updated after the last log-in of the user, corresponds to a step of determining whether or not the profile information has been updated. Furthermore, the process for sending profile information corresponding to the disclosure level (process (5)), corresponds to the step of disclosing the profile information, the disclosure function and the disclosure means.

In the service site having received notification as to whether or not the profile information has been updated, the member information is updated based on the updated profile information as necessary. After the member information is updated, an authentication and update completion message is sent to the user (process (6)). Moreover, if the profile information has not been updated, only user authentication is performed at the service site. Subsequently, the user can begin to use the service site.

In this manner, even when the user is registered as a member of a plurality of service sites, he/she does not need to update his/her profile information individually at each site, and needs only to update the profile information registered in the DB 12 in the information disclosure apparatus 10. When using a service site, if the user sends authentication information with the digital certificate, the service site requests an update confirmation to the information disclosure apparatus 10, and according to the results thereof, updates the member information automatically. Consequently, when updating his/her profile information, the user needs not make update requests of his/her information to a plurality of service sites, and the effort required of the user is greatly reduced.

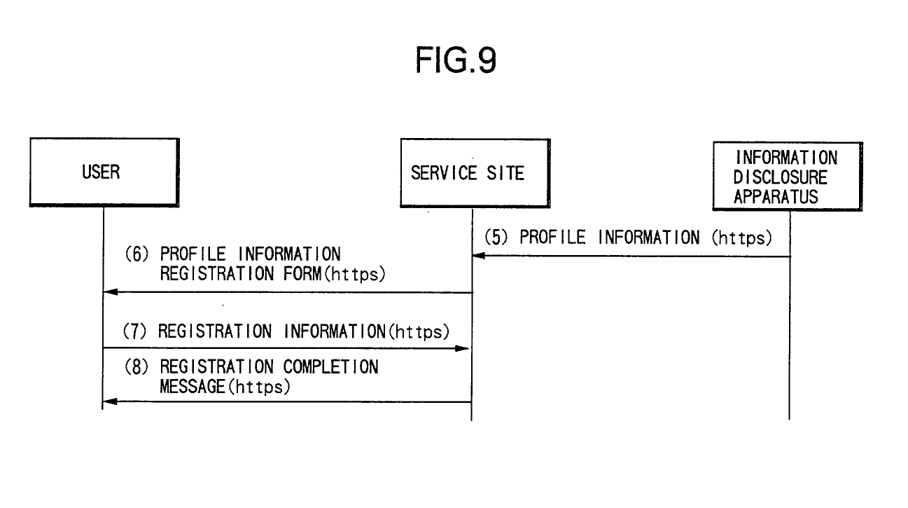

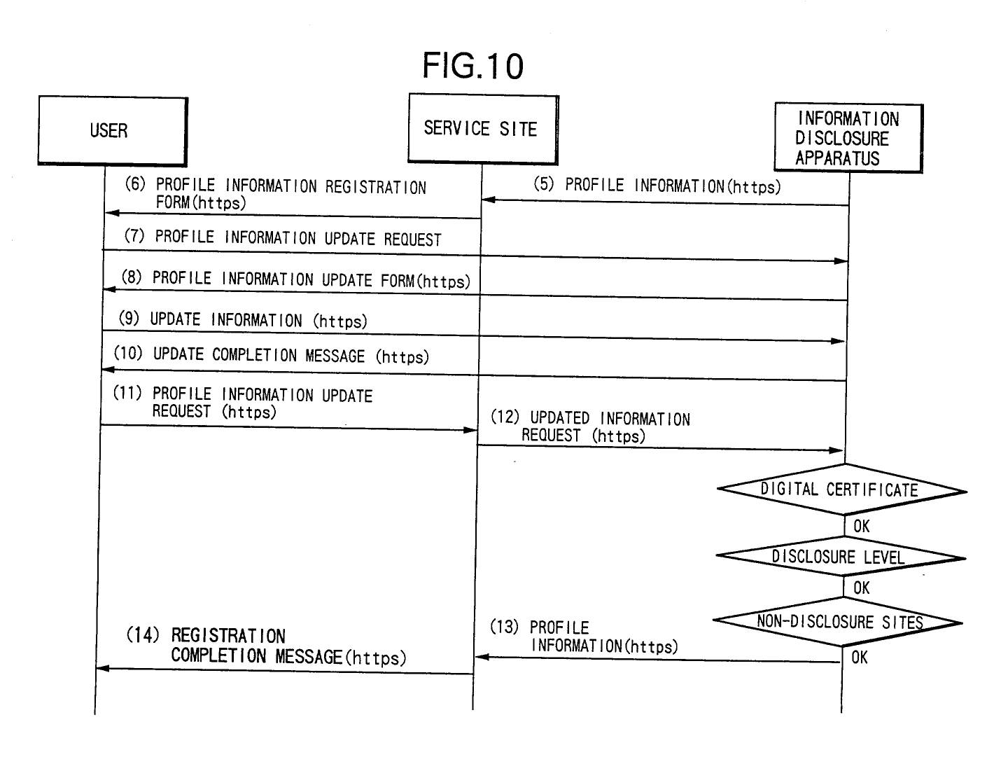

Next, the process is described for the case in which profile information required by the service site is not registered in the information disclosure apparatus 10, with reference to FIG. 9. This process is necessary when, for example, the user has intentionally left entries blank, when the disclosure level is insufficient, or when entries specific to a particular service are required. Note, because process (1) through process (5) are the same as in FIG. 6, they are excluded from both the description below and the figures (the same applies for FIG. 10).

The service site having received the profile information from the information disclosure apparatus 10 (process (5)), determines whether or not any entries required for member registration are missing. If there are missing entries, the entries already registered are set and entered, and a profile information registration form is sent to the user with the missing entries left blank (process (6)). The user having received this profile information registration form, fills in the blank entries, and by then clicking a “register” button for example, sends the registration information with the profile information necessary for member registration, to the service site (process (7)).

The service site having received the registration information, performs the member registration process based on this profile information, and the member information is registered in the DB 42. After the member information has been registered, a registration completion message is sent to the user (process (8)). Subsequently, the user can begin to use the service site.

In this manner, if entries required for member registration are missing, the user is requested to input profile information using the profile information registration form wherein only those entries are blank. Consequently, common profile information can be used regardless of the service offered by the service site. Furthermore, since the user can set the disclosure level and select which entries are to be registered at his/her discretion, the content to be disclosed can be set based on his/her personal preference.

FIG. 10 shows another process to be performed when profile information required by a service site is not registered in the information disclosure apparatus 10.

The service site having received the profile information from the information disclosure apparatus 10 (process (5)), determines whether or not any entries required for member registration are missing. If there are missing entries, the entries already registered are set and entered, and a profile information registration form is sent to the user with the missing entries left blank (process (6)). The user having received the profile information registration form, sends a profile information update request to the information disclosure apparatus 10 (process (7)). Then, a profile information update form is sent to the user from the information disclosure apparatus 10 (process (8)).

The user having received the profile information update form, updates each entry of his/her profile information, the disclosure level and the non-disclosure site table as necessary, and by then clicking an “update” button for example, sends the updated information with the digital certificate to the information disclosure apparatus 10 (process (9)). The information disclosure apparatus 10 having received this updated information, updates the profile information, the disclosure level and the non-disclosure site table based on the updated information. After the profile information and the like have been updated, an update completion message is sent to the user (process (10)).

The user having received this update completion message, sends a profile information update request with the digital certificate to the service site (process (11)). The service site having received the profile information update request, then sends an updated information request with the digital certificate to the information disclosure apparatus 10 (process (12)).

The information disclosure apparatus 10 having received the updated information request, then determines whether or not the profile information may be disclosed to the service site, and if permitted, the profile information corresponding to the disclosure level is sent to the service site (process (13)). Here, the process of sending the profile information corresponding to the disclosure level corresponds to the step of disclosing the profile information, the disclosure function and the disclosure means.

The service site having received the profile information, registers the member information according to the content of the profile information in the DB 42. After the profile information has been registered, a registration completion message is sent to the user (process (14)). Subsequently, the user can begin to use the service site.

In this manner, when performing member registration at a service site, the profile information, the disclosure level and the non-disclosure sites registered in the information disclosure apparatus 10 can be reviewed. Consequently, the frequency of profile information input requests for missing entries is reduced for subsequent member registrations, and the effort required for inputting profile information for member registration can be further reduced.

Moreover, when there are missing entries in the profile information, it is desirable that the user is able to select, according to his/her own preferences, which of the processes shown in FIG. 9 and FIG. 10 is performed.

If a program for realizing such functions is recorded on a computer readable recording medium such as a magnetic tape, a magnetic disc, a magnetic drum, an IC card, a CD-ROM or a DVD-ROM, then the profile information disclosure program according to the present invention can be distributed in the market. A person who acquires this recording medium can then easily construct the profile information disclosure apparatus according to the present invention using a general computer system.

What is claimed is:

1. A profile information disclosure method of sequentially performing: a step of determining, when an information disclosure request appended with identification information of a user is received, whether or not the request is valid, based on said identification information; and a step of disclosing, when the request is determined to be valid, profile information of the user specified by said identification information.

2. A profile information disclosure method according to claim 1, further comprising a step of updating, when an information update request appended with identification information of the user is received, the profile information of the user specified by said identification information.

3. A profile information disclosure method according to claim 1, further comprising: a step of determining, when an update confirmation request appended with identification information of the user is received, whether or not the request is valid, based on said identification information; a step of determining, when the request is determined to be valid, whether or not the profile information of the user specified by said identification information is updated; and a step of disclosing, when determined that the profile information is updated, the updated profile information.

4. A profile information disclosure method according to claim 1,
wherein said step of disclosing profile information, discloses only profile information suited to a disclosure level according to a category of a site to which the information is disclosed.

5. A profile information disclosure method according to claim 1,
wherein said step of disclosing profile information, discloses profile information to information disclosure sites with the exception of predetermined non-disclosure sites.

6. A profile information disclosure method according to claim 1,
wherein said identification information is a digital certificate.

7. A profile information disclosure program for realizing on a computer: a registration function for registering user profile information; a determining function for determining, when an information disclosure request appended with identification information for a user is received, whether or not the request is valid, based on said identification information; and a disclosing function for disclosing, when the request is determined to be valid by said determining function, the profile information of the user specified by said identification information.

8. A profile information disclosure apparatus comprising: registration means for registering user profile information; determining means for determining, when an information disclosure request appended with identification information for a user is received, whether or not the request is valid, based on said identification information; and disclosing means for disclosing, when the request is determined to be valid by said determining means, the profile information of the user specified by said identification information.
